(19) United States
(12) Patent Application Publication
(10) Pub. No.: US 2015/0310548 A1
(43) Pub. Date: Oct. 29, 2015

(54) METHODS OF CONSTRUCTING CURRENCY INDEXES

(71) Applicant: Frank Russell Company, Seattle, WA (US)

(72) Inventors: Joseph Patrick Hoffman, Edmonds, WA (US); Marcin Adam Bednarczyk, Tacoma, WA (US); Catherine Kayo Yoshimoto, Seattle, WA (US); Mary Elizabeth Fjelstad, Seattle, WA (US)

(73) Assignee: Frank Russell Company, Seattle, WA (US)

(21) Appl. No.: 14/263,805

(22) Filed: Apr. 28, 2014

(51) Int. Cl. G06Q 40/04

(52) U.S. Cl. CPC G06Q 40/04

(57) ABSTRACT

A computer-implemented method of constructing a currency carry index performed by one or more computing devices. The method includes calculating a carry metric value for each of a plurality of currencies with respect to a base one of the currencies. For each of the currencies, the carry metric value is calculated based on a forward rate value associated with the currency, and a spot rate value associated with the currency. The method further includes ranking the currencies by their carry metric values, selecting a portion of the currencies for inclusion in the currency carry index based at least in part on the ranking, and assigning a weight value to each currency in the selected portion. The currency carry index includes the selected portion of the currencies weighted according to the weight value assigned to each currency in the selected portion.

### BACKGROUND OF THE INVENTION

1. Field of the Invention

The present invention is directed generally to methods of constructing currency indexes.

2. Description of the Related Art

A “currency carry trade” or “carry trade” is an investment strategy in which an investor sells a certain currency with a relatively low interest rate and uses the funds to purchase a different currency yielding a higher interest rate. A trader using this strategy attempts to capture the difference between the rates, which can often be substantial, depending on the amount of leverage used.

A positive “carry” is a strategy of holding two offsetting positions, one of which creates an incoming cashflow that is greater than the obligations of the other position.

A significant risk associated with currency carry trades is the uncertainty of exchange rates. For example, if the value of the currency with the higher interest rate decreases relative to the currency with the lower interest rate, the investor may lose money.

The carry trade is widely accepted as a key driver of currency returns globally. See, e.g., Lustig, H., N. Roussanov and A. Verdelhan, “Common Risk Factors in Currency Markets,” Review of Financial Studies 24(11): 3731-3777 (2011); and Burnside, C., M. Eichenbaum and S. Rebelo, “Carry Trade and Momentum in Currency Markets,” Annual Review of Financial Economics v. 3: 511:535 (2011).

A currency carry index measures carry (returns or costs) associated with holding one currency relative to carry associated with holding one or more different currencies. However, calculating carry for multiple currencies is complicated. Unfortunately, such similar interest rate vehicles (similar in tenor or maturity, similar in regulation, etc.) do not exist across enough markets, countries, and/or regions to create a meaningful and valid index for currency carry globally, even among developed countries.

Therefore, one challenge to creating a currency carry index is to identify an interest rate measure across different markets, countries, and/or regions that is consistent, valid (based as much as possible on market measures) and investable. In the past, London Interbank Offered Rate (“LIBOR”) values have been used as short-term interest rate measures across countries and currencies in currency index construction, as well as in academic and practitioner research and reporting. LIBOR values are average interest rate values (estimated by leading banks in London) that participating banks report they believe they would be charged when borrowing money from one another. LIBOR rate values are calculated for several currencies and multiple borrowing periods.

Unfortunately, using LIBOR has several drawbacks. First, as recent scandals have shown, LIBOR is subject to manipulation and fraud. Thus, LIBOR does not represent an objective interest rate determined by the market. Second, LIBOR is not investable, at least not by a general investor or a buy-side institutional investor. At best, LIBOR represents an average rate at which a select group of large banks operating in the London interbank lending market believe they can borrow short term funds from one another. Third, a large portion of historical LIBOR values cannot be used to calculate historical index values. Index construction requires the creation of a credible historical time-series of constituents and index returns. Unfortunately, the LIBOR scandals have tarnished the validity of historical LIBOR values at least as far back as 2005. And finally, LIBOR values are no longer available for some currencies. In 2013, the number of LIBOR currencies was reduced from ten to five; computation for the Danish krone, Swedish krone, New Zealand dollar, Australian dollar and Canadian dollar ceased. The remaining LIBOR currencies are the euro, U.S. dollar, British pound sterling, Japanese yen, and Swiss franc.

Thus, using LIBOR as the currency carry measure would significantly reduce the opportunity set for currency carry.

Other interest rate measures across different currencies have similar drawbacks. For example, overnight government rate values (such as the federal funds rate in the U.S.) are available to (and investable by) participating banks only. Thus, such overnight government rate values are not investable by non-bank investors. Further, such rate values may be subject to manipulation by central banking authorities attempting to manage economic conditions.

The one-month U.S. Treasury Bill rates could be used if equivalent rates existed in other countries and for other currencies. Unfortunately, they do not. Most notably, no such investment vehicle exists for European currencies. Finally, while other interbank offer rate values (for example, Norwegian Interbank Offered Rate (“NIBOR”) values) are currently available, there is no guarantee across jurisdictions of uniformity in the reporting or estimation of these rate values. Like LIBOR values, these other interbank offer rate values are not market-based, and may be subject to fraud and manipulation.

Therefore, a need exists for new methods of measuring interest rates across a plurality of different markets/currencies in order to estimate carry. A desirable carry metric would be consistent, based as much as possible on market measures, and investable. A need also exists for methods of constructing, calculating, and reconstituting a currency carry index that captures returns from combining long positions in high-yielding currencies with short positions in low-yielding currencies. The present application provides these and other advantages as will be apparent from the following detailed description and accompanying figures.

### BRIEF DESCRIPTION OF THE SEVERAL VIEWS OF THE DRAWING(S)

FIG. 1 is a diagram of a system including one or more computing devices configured to implement a combined currency index, a currency carry index, a currency value index, and a currency trend index.

FIG. 2 is a flow diagram of a method of constructing the currency carry index performed by one or more computing devices of the system of FIG. 1.

FIG. 3 is a table listing an exemplary pool of ten candidate currencies from which currencies may be selected for inclusion in one or more of the indexes.

FIG. 4 is a table listing closing one-month future forward rate values for each trading day on a selected exchange during a predetermined period of time (Jan. 11, 2013 to Jan. 24, 2013) for each of the candidate currencies.

FIG. 5 is a table listing closing spot rate values for each trading day on the selected exchange during the predetermined period of time for each of the candidate currencies (except a base currency).

FIG. 6 is a table listing (a) ratio values obtained by dividing each of the closing one-month future forward rate values of FIG. 4 by a corresponding one of the closing spot rate values of FIG. 5, and (b) an average ratio value (or carry metric value) for each currency over the predetermined period of time.

FIG. 7 is a table listing the candidate currencies ranked in descending order by their carry metric values, and identifying exemplary weight values assigned to selected ones of the currencies.

FIG. 8 is a flow diagram of a method of maintaining the currency carry index.

FIG. 9 is a flow diagram of an exemplary method of calculating an index value for the currency carry index.

FIG. 10 is a table listing closing Purchasing Power Parity (“PPP”) values for each of the candidate currencies relative to the base currency, on Jan. 24, 2013.

FIG. 11 is a table listing the candidate currencies ranked in ascending order by their value metric values, and identifying exemplary weight values assigned to selected ones of the currencies in the currency value index.

FIG. 12 is a table listing the candidate currencies ranked in descending order by their trend metric values, and identifying exemplary weight values assigned to selected ones of the currencies in the currency trend index.

FIG. 13 is a table identifying exemplary weight values assigned to the candidate currencies in the combined currency index.

FIG. 14 is a diagram of a hardware environment and an operating environment in which the one or more computing devices of the system of FIG. 1 may be implemented.

### DETAILED DESCRIPTION OF THE INVENTION

Forward contracts may be used to invest in different currencies. A forward contract is an agreement between two parties to purchase or sell an underlying asset (e.g., a first currency) at a specified future time (e.g., in one month) at an agreed upon delivery price (e.g., in a different second currency) set when the contract is made and due at the specified future time. The party agreeing to purchase the underlying asset in the future is referred to as having a long position. On the other hand, the party agreeing to sell the asset in the future is referred to as having a short position. Often, at the specified future time, the parties simply exchange the difference between a current (or spot) value of the asset and the delivery price instead of exchanging the asset for the delivery price.

If the underlying asset is a number of units of a particular currency (e.g., 100 Euros), instead of specifying a delivery price, a forward contract for the asset may specify a forward rate value (e.g., 132%) at which a second currency will be exchanged for the number of units of the particular currency at the specified future time (e.g., in one month). The delivery price is then calculated based on the specified forward rate value.

For example, if the current spot rate for one Euro is 1.32 U.S. dollars, 100 Euros today would cost 132 U.S. dollars. If the first party believes the value of the Euro relative to the U.S. dollar will increase in the next month, the first party may offer to purchase 100 Euros using U.S. dollars at a forward rate value of 1.32 (which means the delivery price will be 132 U.S. dollars). If the second party believes the value of the Euro relative to the U.S. dollar will decrease in the next month, the second party may offer to sell 100 Euros in one month to the first party at the forward rate value of 1.32 (or at the delivery price of 132 U.S. dollars). Ignoring costs and fees associated with this exemplary one-month future forward contract, if the spot rate value in one month is the same as the forward rate value, neither party will make or lose money. If the value of the Euro relative to the U.S. dollar increases (e.g., the future spot rate value for one Euro is 1.38 U.S. dollars) in the next month, the first party will earn the difference between the forward rate value and the future spot rate value for 100 Euros in U.S. dollars in one month (which in this example is six U.S. dollars). On the other hand, if the value of the Euro relative to the U.S. dollar decreases (e.g., the future spot rate value for one Euro is 1.28 U.S. dollars) in the next month, the first party will lose the difference between the forward rate value and the future spot rate value for the 100 Euros in U.S. dollars in one month (which in this example is four U.S. dollars). In this example, the first party has the long position and the risk associated with holding the underlying asset (namely, 100 Euros) instead of U.S. dollars for one month. On the other hand, the second party has the short position and the risk associated with holding U.S. dollars instead of the underlying asset (namely, 100 Euros) for one month.

A currency carry index may be used as a benchmark for an investor and/or a basis for a fund (e.g., an exchange traded fund (“ETF”), passive fund, mutual fund, and the like) implementing an investment strategy that involves purchasing one or more future forward contracts for a first set of currencies over a period of time, and one or more short forward contracts for a second set of currencies over the same period of time. As is apparent to those of ordinary skill in the art, the currency carry index may also be the basis for index derivatives contracts. It is desirable that the first set of currencies include positive high-yielding currencies, and the second set of currencies include negative or low-yielding currencies. Thus, the currency carry index may be configured to measure long positions in positive high-yielding currencies, and short positions in negative or low-yielding currencies.

### System

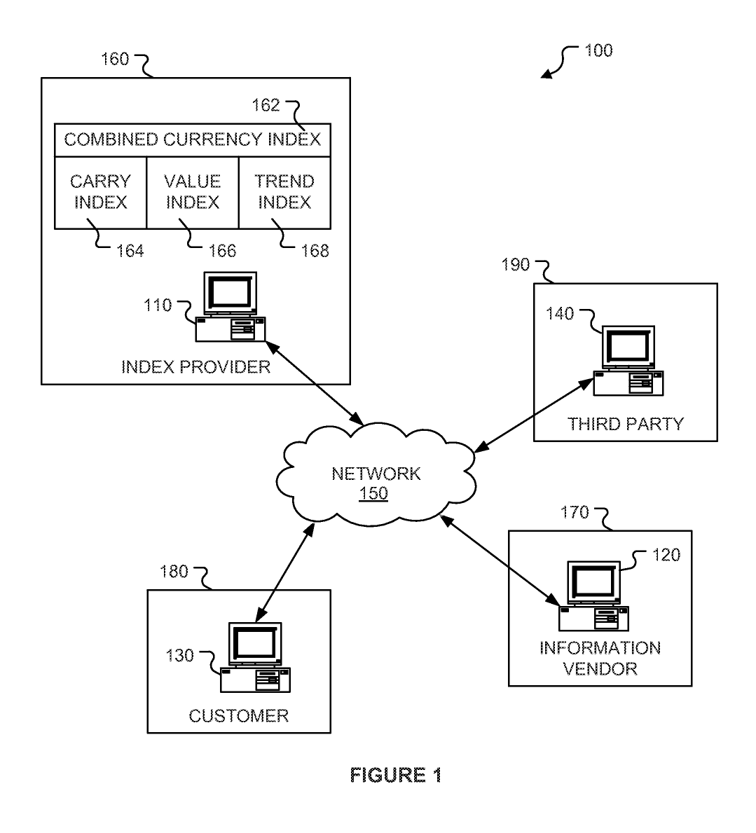

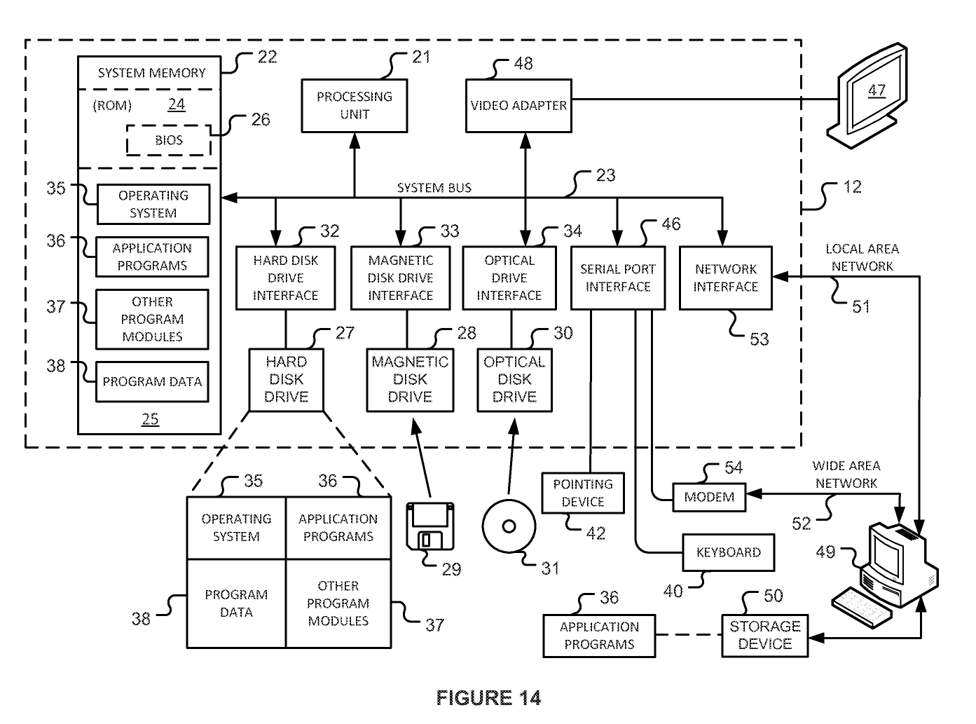

FIG. 1 is a diagram illustrating a system 100 for calculating one or more currency indexes. The system 100 includes computing devices 110, 120, 130, and 140 connected to one another by a network 150 (such as the Internet). The computing devices 110, 120, 130, and 140 may each be implemented using one or more computing devices like a computing device 12 depicted in FIG. 14 and described below.

The computing device 110 is operated by an index provider 160. The computing device 110 is configured to receive information from the computing device 120, which is operated by an information vendor 170. By way of a non-limiting example, the information vendor 170 may include The World Markets Company PLC (doing business as WM/Reuters) operating a website at http://www.wmcompany.com.

The computing device 110 constructs, maintains, and reconstitutes at least one currency index (e.g., a combined currency index 162, a currency carry index 164, a currency value index 166, and a currency trend index 168) based at least in part on information received from the computing device 120. In the example illustrated in FIG. 1, the combined currency index 162 is calculated based at least in part on the currency carry index 164, the currency value index 166, and the currency trend index 168. The computing device 110 calculates an index value occasionally (e.g., daily) for each currency index (e.g., the indexes 162-168) and sends the index value to the computing device 130, which is operated by a customer 180 of index values. By way of a non-limiting example, the customer 180 may be an exchange, a publication, a fund, and the like.

The computing device 140 may be operated by a third party 190, such as an investor, news organization, and the like. The computing device 140 may obtain index values from the customer 180 (e.g., via the computing device 130 over the network 150), or the index provider 160 (e.g., via the computing device 110 over the network 150).

### Currency Carry Index

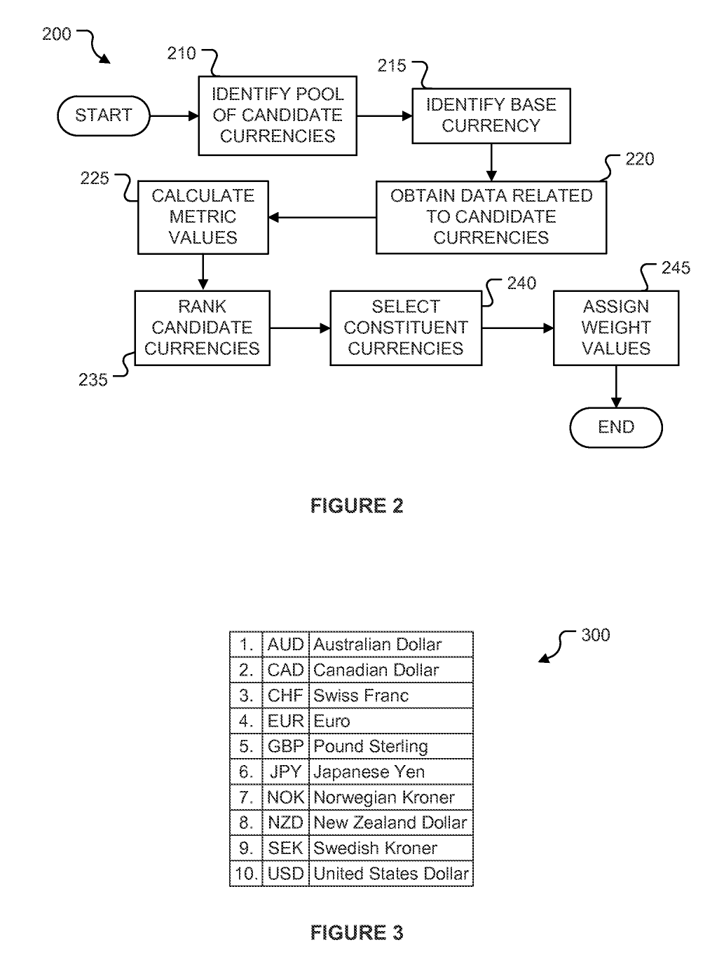

FIG. 2 is a flow diagram of a method 200 that may be performed by one or more computing devices (e.g., the computing device 110 illustrated in FIG. 1). For ease of illustration, the method 200 will be described as being performed by the computing device 110 (see FIG. 1) and constructing the currency carry index 164 (see FIG. 1).

In a first block 210, the computing device 110 identifies a pool of candidate currencies. By way of a non-limiting example, an exemplary pool of candidate currencies 300 is illustrated in FIG. 3. The illustrated pool of candidate currencies 300 includes major developed market currencies.

Returning to FIG. 2, in block 215, the computing device 110 identifies (or selects) a reference or base currency (e.g., U.S. dollar). For ease of illustration, the base currency will be described as being the U.S. dollar. However, this is not a requirement and other currencies may be used.

In block 220, the computing device 110 obtains data related to the candidate currencies. For example, when calculating values for the currency carry index 164, the computing device 110 obtains closing one-month future forward rate values and closing spot rate values for each of the candidate currencies with respect to the base currency for a first predetermined period of time. In other words, each of these values represents a rate at which one of the candidate currencies may be exchanged for the base currency. By way of a non-limiting example, the first predetermined period of time may include each of the previous ten trading days on a selected exchange. Daily closing spot rate values and daily closing one-month future forward rate values may be obtained from the information vendor 170 (see FIG. 1) via the network 150 (see FIG. 1).

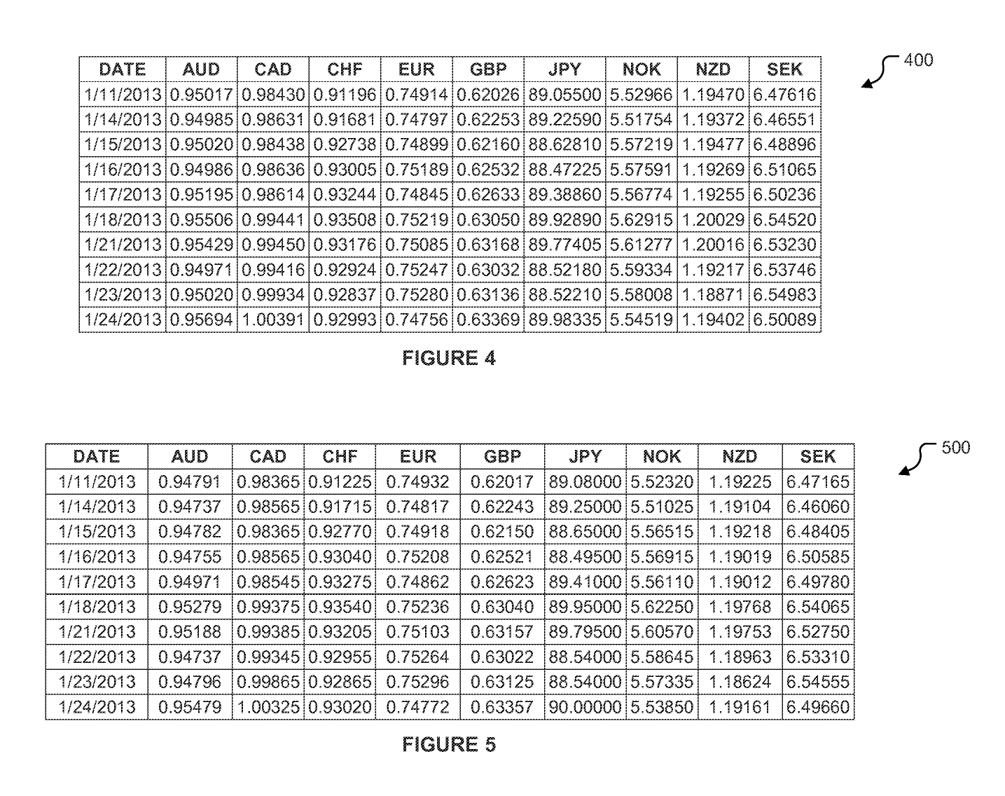

FIG. 4 depicts a table 400 listing an exemplary closing one-month future forward rate value for each trading day on the selected exchange from Jan. 11, 2013 to Jan. 24, 2013, for each of the candidate currencies listed in the table 300 (see FIG. 3), except the base currency. The closing one-month future forward rate value is a specified exchange rate value (available at market close) at which a counterparty will agree to exchange the candidate currency for the base currency in one month. In other words, the closing one-month future forward rate value is the exchange rate value specified in a future forward contract purchasable at market close in which the counterparty agrees to purchase the candidate currency with the base currency in one month and at the specified exchange rate value (which, as explained above, may be used to calculate the delivery price).

FIG. 5 depicts a table 500 listing an exemplary closing spot rate value for each trading day on the selected exchange from Jan. 11, 2013 to Jan. 24, 2013 for each of the candidate currencies listed in the table 300 (see FIG. 3), except the base currency. The closing spot rate value is an exchange rate value, at market close (of the selected exchange), at which a counterparty will exchange the constituent currency for the base currency on the spot.

In the example illustrated in FIGS. 4-7, the method 200 is being performed after the close of trading on the selected exchange on Thursday, Jan. 24, 2013 and before the close of trading on the selected exchange on Friday, Jan. 25, 2013. Thus, FIGS. 4 and 5 depict closing one-month future forward rate values and closing spot rate values, respectively, for each of the ten previous trading days on the selected exchange. For ease of illustration, in block 220, the computing device 110 obtains the information depicted in FIGS. 4 and 5.

In block 225, the computing device 110 calculates a metric value for each of the candidate currencies. For example, when constructing the currency carry index 164, in block 225, the computing device 110 calculates a carry metric value for each of the candidate currencies.

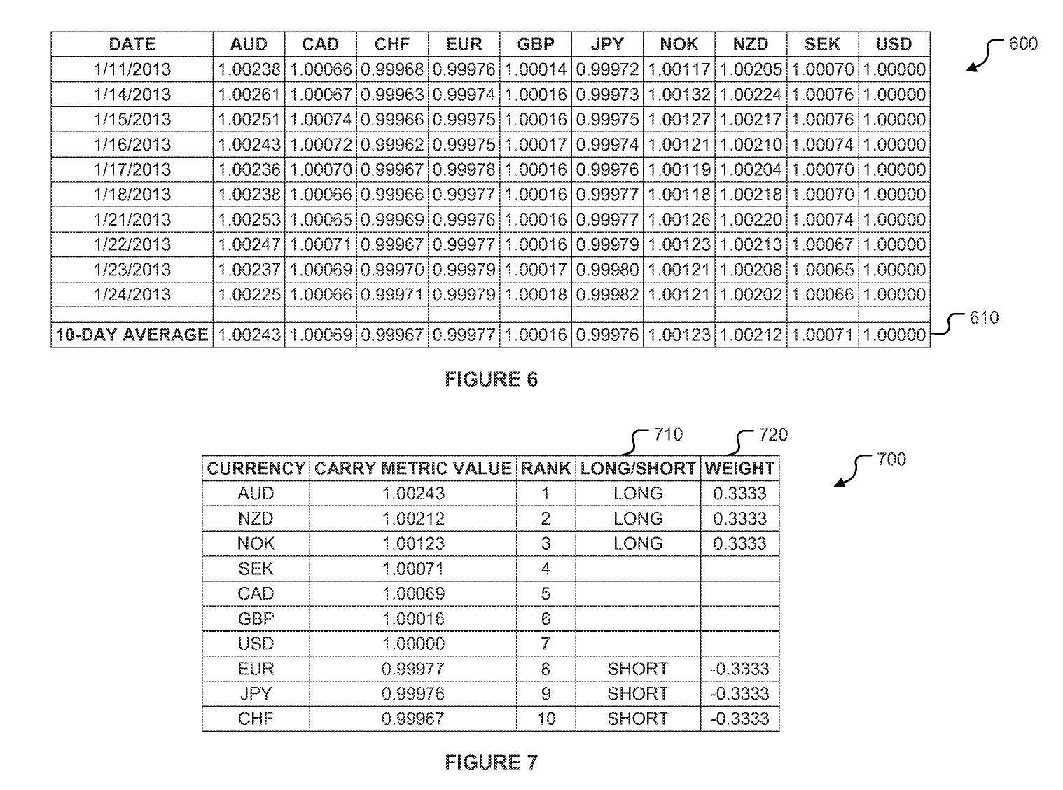

The carry metric values may be calculated by first calculating a ratio value for each of the candidate currencies for each trading day on the selected exchange during the first predetermined period of time. The ratio value for a particular trading day and a selected candidate currency is calculated by dividing the closing one-month future forward rate value for the particular trading day and selected currency by the closing spot rate value for the particular trading day and selected currency. FIG. 6 depicts a table 600 listing exemplary ratio values calculated from the information depicted in FIGS. 4 and 5. For each candidate currency, the ratio value measures the expected carry (return or cost) of holding the candidate currency for one month. As shown in FIG. 6, the base currency (e.g., U.S. dollar) may be assigned a ratio value equal to one for each trading day.

If the first predetermined period of time includes a single trading day, for each candidate currency, the carry metric value is set equal to the ratio value. On the other hand, if the first predetermined period of time includes more than one trading day, the computing device 110 calculates the carry metric value by averaging the ratio values calculated for each candidate currency. Thus, the carry metric value for each candidate currency may be an average of the ratio values determined for the currency over the first predetermined period of time (e.g., ten days). Referring to FIG. 6, a row 610 depicts an exemplary (10-day) carry metric value calculated for each of the candidate currencies. As shown in FIG. 6, the carry metric value for the base currency (e.g., the U.S. dollar) may be set equal to one.

Returning to FIG. 2, in block 235, the computing device 110 sorts or ranks the candidate currencies. In this example, the candidate currencies are ranked in descending order by their carry metric values. Thus, the computing device 110 assigns higher ranks to those constituent currencies having larger carry metric values than those constituent currencies having smaller carry metric values. FIG. 7 depicts a table 700 in which the candidate currencies have been ranked (in descending order) by their carry metric values (calculated in block 225 and illustrated in the row 610 of the table 600 in FIG. 6).

Returning to FIG. 2, in block 240, the computing device 110 selects a predetermined number of candidate currencies for inclusion in the currency carry index 164 as constituent currencies. By way of a non-limiting example, the candidate currencies having the three largest carry metric values, and the candidate currencies having the three smallest carry metric values may be selected in block 240. In FIG. 7, the candidate currencies having the three largest carry metric values (labeled “LONG” in a column 710 of the table 700) are selected for long positions, and the candidate currencies having the three smallest carry metric values (labeled “SHORT” in the column 710 of the table 700) are selected for short positions.

Returning to FIG. 2, in block 245, the computing device 110 assigns a weight value to each of the constituent currencies (selected in block 240). By way of a non-limiting example, positive non-zero weight values may be assigned to currencies selected for long positions, and negative non-zero weight values may be assigned to currencies selected for short positions. The weight values assigned to those currencies selected for long positions may be equal to one divided by the number of currencies selected for long positions. Similarly, the weight values assigned to those currencies selected for short positions may be equal to negative one divided by the number of currencies selected for short positions. A column 720 in the table 700 depicted in FIG. 7 illustrates exemplary weight values assigned to the constituent currencies. In this example, the candidate currencies having the three largest carry metric values have each been assigned a weight value equal to positive one third (or ⅓), and the candidate currencies having the three smallest carry metric values have each been assigned a weight value equal to negative one third (or −⅓).

In the example illustrated, the computing device 110 assigns a weight value other than zero to each of the constituent currencies (selected in block 240). Optionally, the computing device 110 assigns a weight value equal to zero to any of the candidate currencies that were not selected in block 240 (see FIG. 2). In such embodiments, in block 245, the computing device 110 assigns a weight value to all of the candidate currencies.

After block 245, the method 200 terminates.

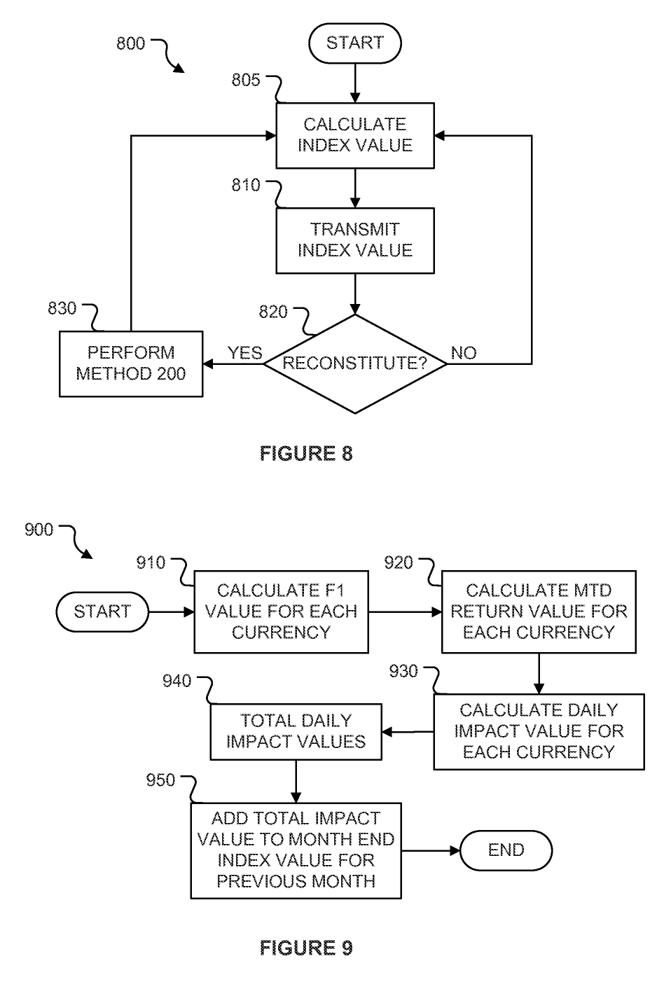

The currency carry index 164 created using the method 200 simulates holding long positions (purchasing one-month future forward contracts) for those constituent currencies labeled “LONG” in column 710 of FIG. 7, and short positions (purchasing one-month short forward contracts) for those constituent currencies labeled “SHORT” in column 710 of FIG. 7. After the method 200 is performed, the constituent currencies of the currency carry index and the weight values assigned to each constituent currency have been determined. Thus, at this point, an index value may be calculated (e.g., using a method 800 illustrated in FIG. 8 and discussed below) occasionally (e.g., periodically) for the currency carry index 164, and sent to the customer 180 (see FIG. 1).

The method 800 may be performed by the computing device 110 occasionally (e.g., daily) to calculate the value of the currency carry index 164.

In first block 805, the computing device 110 calculates an index value. The index value may be calculated as follows. First, the computing device 110 calculates a contribution value for each constituent currency by multiplying the closing one-month future forward rate value for the currency determined on a selected trading day on the selected exchange by the weight value assigned to the constituent currency in block 245 of the method 200 illustrated in FIG. 2. Then, the computing device 110 totals the contribution values for the constituent currencies. Optionally, the computing device 100 multiplies this total by a number of units (e.g., 100) of the constituent currencies specified in future and/or short forward contracts. For example, in the table 400 illustrated in FIG. 4, on Jan. 24, 2013, the closing one-month future forward rate values of the constituent currencies AUD, NZD, NOK, EUR, JPY, and CHF are 0.95694, 1.19402, 5.54519, 0.74756, 89.98335, and 0.92993, respectively. Further, as shown in the table 700 of FIG. 7, the weight values assigned to the constituent currencies AUD, NZD, NOK, EUR, JPY, and CHF are 0.3333, 0.3333, 0.3333, −0.3333, −0.3333, and −0.3333, respectively. If the number of units is 100, the currency index value for Jan. 24, 2013 would be about −2,798.82 (−2,798.82=100*((0.95694*0.3333)+(1.19402*0.3333)+(5.54519*0.3333)+(0.74756*−0.3333)+(89.98335*−0.3333)+(0.92993*−0.3333))).

Alternatively, a method 900 illustrated by a flow diagram provided in FIG. 9 may be performed in block 805. The method 900 accounts for compounding on a daily basis throughout the month.

In block 810, referring to FIG. 1, the computing device 110 transmits the index value to the computing device 130 (operated by the customer 180) over the network 150. Next, referring to FIG. 8, the computing device 110 advances to decision block 820.

In decision block 820, the computing device 110 determines whether the currency carry index is to be reconstituted. By way of a non-limiting example, the currency carry index may be rebalanced occasionally, such as periodically (e.g., monthly).

When the decision in decision block 820 is “YES,” in block 830, the method 200 is performed. Then, the computing device 110 returns to block 805 to calculate the next index value.

When the decision in decision block 820 is “NO,” the computing device 110 returns to block 805 to calculate the next index value.

As mentioned above, the index value calculated in block 805 may be calculated using the method 900 illustrated in FIG. 9. Turning to FIG. 9, in first block 910, the computing device 110 calculates an F1 value for each of the constituent currencies for the current trading day. For each of the constituent currencies, the computing device 110 calculates a difference between a total number of trading days (e.g., 20) in the current month and the current trading day (e.g., 12). Then, the computing device 110 divides the difference (e.g., 20-12) by the total number of trading days (e.g., 20) in the current month to obtain a fraction of the month (e.g., 0.4). The computing device 110 multiplies the fraction by a difference between the closing one-month future forward rate value on the current day and the closing spot rate value on the current day. Lastly, the computing device 110 obtains the F1 value by adding the closing spot rate value on the current day to the product of the fraction and the difference between the closing one-month future forward rate value and the closing spot rate value. For example, using the exemplary values provided above and in FIGS. 4 and 5, the F1 value for the constituent currency “AUD” on Jan. 24, 2013 would be 0.95565 (0.95565=0.4*(0.95694−0.95479)+0.95479).

In next block 920, the computing device 110 calculates a month to date (“MTD”) Return value for each of the constituent currencies for the current month. For each of the constituent currencies, the computing device 110 divides a previous month end forward rate value by the F1 value calculated in block 910 and subtracts negative one from the result to obtain the MTD value for the currency. For example, using the exemplary values provided above, if the month end forward rate value for the constituent currency “AUD” for December 2012 is 0.99999, the MTD value for this currency would be 0.04640 (0.04640=0.99999/0.95565−1).

In next block 930, the computing device 110 calculates a daily impact value for each of the constituent currencies. For each of the constituent currencies, the computing device 110 multiplies the MTD value for the currency by the weight value assigned to the currency to obtain the daily impact value for the currency. For example, using the exemplary values provided above, for the constituent currency “AUD,” the daily impact value would be 0.01547 (0.01547=0.04640*0.3333).

Then, in block 940, the computing device 110 totals the daily impact values for the constituent currencies to obtain a total impact value. The total impact value is a measure of the combined performance of the constituent currencies on that day.

In block 950, the computing device 110 adds the total impact value to a month end index value calculated for the previous month (e.g., December 2012) to obtain the index value.

Then, the method 900 terminates.

### Currency Value Index

Like the currency carry index 164, the currency value index 166 may be used as a benchmark for an investor and/or a basis for a fund (e.g., an exchange traded fund (“ETF”), passive fund, mutual fund, and the like) implementing an investment strategy that involves purchasing one or more future forward contracts for a first set of currencies over a period of time, and one or more short forward contracts for a second set of currencies over the same period of time. As is apparent to those of ordinary skill in the art, the currency value index 166 may also be the basis for index derivatives contracts. It is desirable that the first set of currencies include undervalued currencies, and the second set of currencies include overvalued currencies. Thus, the currency value index 166 may be configured to measure long positions in undervalued currencies, and short positions in overvalued currencies.

The currency value index 166 may be constructed using a method (not shown) substantially similar to the method 200 used to construct the currency carry index 164. However, in block 220, instead of obtaining closing one-month future forward rate values and closing spot rate values for the first predetermined period of time for each of the candidate currencies with respect to the base currency, the computing device 110 obtains the following values:
1 inverses of the closing spot rate values for each of the candidate currencies with respect to the base currency for a second predetermined period of time; and
2. inverses of closing Purchasing Power Parity (“PPP”) values for each of the candidate currencies with respect to the base currency for the last day in the second predetermined period of time.
   By way of a non-limiting example, the second predetermined period of time may be 20 trading days.

For each of the closing spot rate values for each of the candidate currencies, the inverse may be found by dividing one by the closing spot rate value (or 1/(closing spot rate value)).

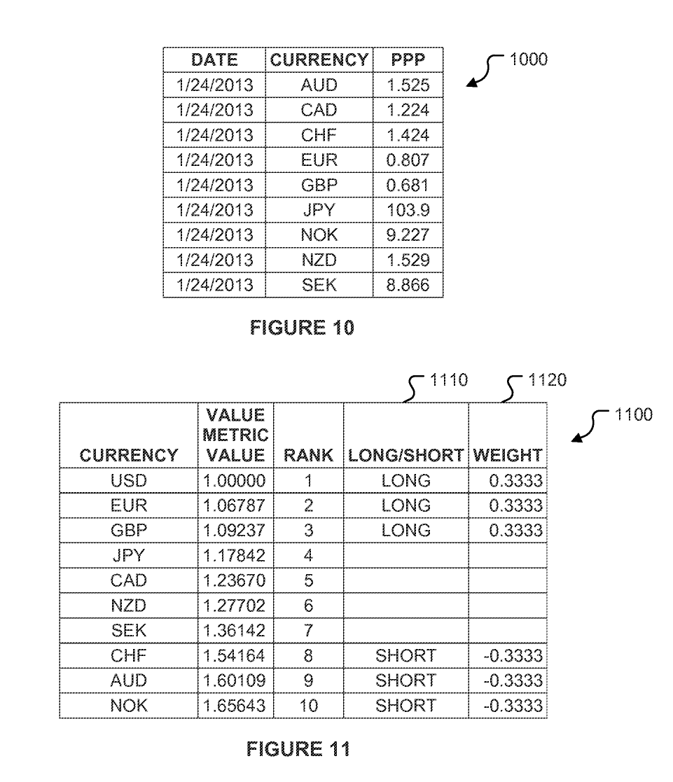

FIG. 10 depicts a table 1000 listing an exemplary PPP value for Jan. 24, 2013, for each of the candidate currencies listed in the table 300 (see FIG. 3), except the base currency. For each of the PPP values, the inverse of the PPP value may be obtained by dividing one by the PPP value (or 1/(PPP value)).

In block 225, instead of calculating ratio values, for each of the candidate currencies, the computing device 110 calculates an average inverse closing spot rate value over the second predetermined period of time.

Then, instead of calculating carry metric values, the computing device 110 calculates a value metric value for each of the candidate currencies. The computing device 110 calculates the value metric value for each of the candidate currencies by dividing the average inverse closing spot rate value calculated for the currency by the inverse closing PPP value for the currency.

The value metric values are used in block 235, 240, and 245 instead of the carry metric values to rank the candidate currencies, select the constituent currencies, and assign weight values to the constituent currencies, respectively. However, in block 235, the currencies are ranked by their value metric values in ascending order, instead of descending order. Thus, currencies with smaller value metric values are assigned higher ranks than currencies with larger value metric values.

FIG. 11 depicts a table 1100 in which the candidate currencies have been ranked (in ascending order) by their value metric values. The candidate currencies having the three smallest value metric values (labeled “LONG” in a column 1110) are selected for long positions, and the candidate currencies having the three largest value metric values (labeled “SHORT” in the column 1110) are selected for short positions. A column 1120 in the table 1100 illustrates exemplary weight values assigned to the constituent currencies. In this example, the candidate currencies having the three smallest value metric values have each been assigned a weight value equal to positive one third (or ⅓), and the candidate currencies having the three largest value metric values have each been assigned a weight value equal to negative one third (or −⅓). Optionally, the computing device 110 assigns a weight value equal to zero to each of the candidate currencies that were not selected in block 240 (see FIG. 2). In such embodiments, in block 245, the computing device 110 assigns a weight value to each of the candidate currencies.

The currency value index 166 (see FIG. 1) created using the modified method 200 simulates holding long positions (purchasing one-month future forward contracts) for those constituent currencies labeled “LONG” in column 1110 of FIG. 11, and short positions (purchasing one-month short forward contracts) for those constituent currencies labeled “SHORT” in column 1110 of FIG. 11. After the modified method 200 is performed, the constituent currencies of the currency value index 166 and the weight values assigned to each constituent have been determined.

At this point, an index value may be calculated using a method like the method 800 illustrated in FIG. 8 and discussed below) occasionally (e.g., periodically) for the currency value index 166, and sent to the customer 180 (see FIG. 1). However, in block 810, the index value for the currency value index 166 is calculated as follows. First, the computing device 110 calculates a contribution value for each constituent currency by multiplying the closing one-month future forward rate value for the currency determined on a selected trading day on the selected exchange by the weight value assigned to the constituent currency. Then, the computing device 110 totals the contribution values for the constituent currencies. Optionally, the computing device 100 multiplies this total by a number of units (e.g., 100) of the constituent currencies specified in future and/or short forward contracts. For example, in the table 400 illustrated in FIG. 4, on Jan. 24, 2013, the closing one-month future forward rate values of the candidate currencies USD, EUR, GBP, CHF, AUD, and NOK are 1.00000, 0.74756, 0.63369, 0.92993, 0.95694, and 5.54519, respectively. Further, in the table 1100 in FIG. 11, the weight values assigned to the candidate currencies USD, EUR, GBP, CHF, AUD, and NOK are 0.3333, 0.3333, 0.3333, −0.3333, −0.3333, and −0.3333, respectively. If the number of units is 100, the currency index value for Jan. 24, 2013 would be about −168 (−168=100*((1.00000*0.3333)+(0.74756*0.3333)+(0.63369*0.3333)+(0.92993*−0.3333)+(0.95694*−0.3333)+(5.54519*−0.3333))).

### Currency Trend Index

Like the currency carry index 164, the currency trend index 168 may be used as a benchmark for an investor and/or a basis for fund (e.g., an exchange traded fund (“ETF”), passive fund, mutual fund, and the like) implementing an investment strategy that involves purchasing one or more future forward contracts for a first set of currencies over a period of time, and one or more short forward contracts for a second set of currencies over the same period of time. As is apparent to those of ordinary skill in the art, the currency trend index 168 may also be the basis for index derivatives contracts. It is desirable for the first set of currencies to be positive trend currencies, and the second set of currencies to be negative trend currencies. Thus, the currency trend index 168 may be configured to measure long positions in positive trend currencies, and short positions in negative trend currencies.

The currency trend index 168 may be constructed using a method (not shown) substantially similar to the method 200 used to construct the currency carry index 164. However, in block 220, instead of obtaining closing one-month future forward rate values and closing spot rate values for the first predetermined period of time for each of the candidate currencies with respect to the base currency, the computing device 110 obtains inverse closing spot rate values for a third predetermined period of time for each of the candidate currencies with respect to the base currency. By way of a non-limiting example, the third predetermined period of time may be 200 trading days. For each of the closing one-month future forward rate values for each of the candidate currencies, the inverse may be found by dividing one by the closing one-month future forward rate value.

Then, in block 225, instead of calculating ratio values, for each of the candidate currencies, the computing device 110 calculates a first average inverse closing spot rate value over the third predetermined period of time, and a second average inverse closing spot rate value over a fourth predetermined period of time. The fourth predetermined period of time is shorter than the third predetermined period of time. By way of a non-limiting example, the fourth predetermined period of time may be 50 trading days.

Next, instead of calculating carry metric values, the computing device 110 calculates a trend metric value for each of the candidate currencies. The computing device 110 calculates the trend metric value for each of the candidate currencies by dividing the second average by the first average and subtracting one from the result.

Then, the trend metric values are used in block 235, 240, and 245 instead of the carry metric values to rank the candidate currencies, select the constituent currencies, and assign weight values to the constituent currencies, respectively.

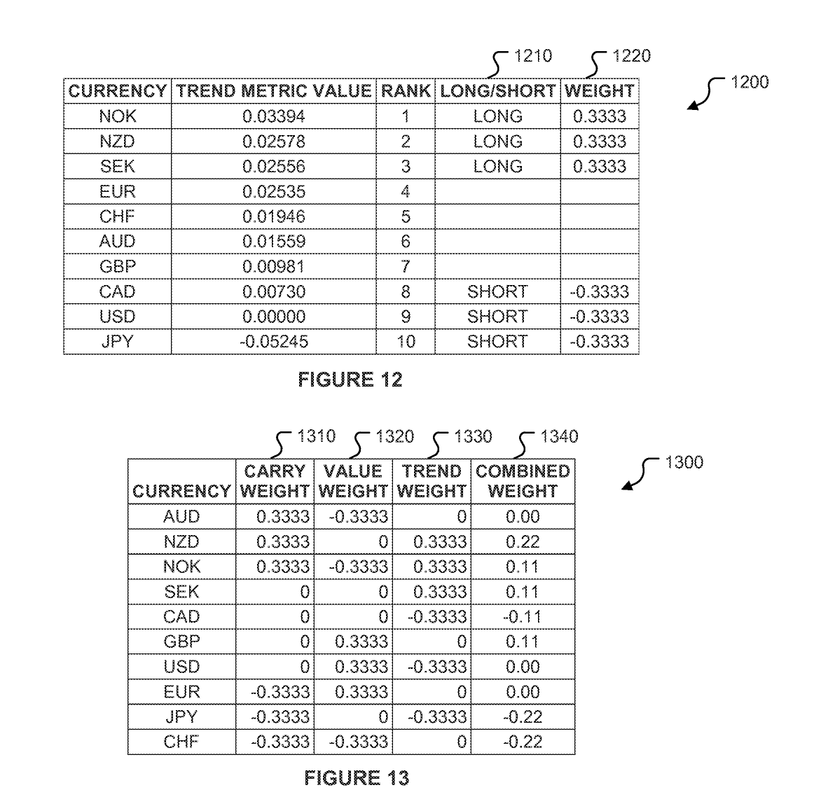

FIG. 12 depicts a table 1200 in which the candidate currencies have been ranked (in descending order) by their trend metric values. The candidate currencies having the three largest trend metric values (labeled “LONG” in a column 1210) are selected for long positions, and the candidate currencies having the three smallest trend metric values (labeled “SHORT” in the column 1210) are selected for short positions. A column 1220 in the table 1200 illustrates exemplary weight values assigned to the constituent currencies. In this example, the candidate currencies having the three largest trend metric values have each been assigned a weight value equal to positive one third (or ⅓), and the candidate currencies having the three smallest trend metric values have each been assigned a weight value equal to negative one third (or −⅓). Optionally, the computing device 110 assigns a weight value equal to zero to each of the candidate currencies that were not selected in block 240 (see FIG. 2). In such embodiments, in block 245, the computing device 110 assigns a weight value to each of the candidate currencies.

The currency trend index 168 (see FIG. 1) created using the modified method 200 simulates holding long positions (purchasing one-month future forward contracts) for those constituent currencies labeled “LONG” in column 1210 of FIG. 12, and short positions (purchasing one-month short forward contracts) for those constituent currencies labeled “SHORT” in column 1210 of FIG. 12. After the modified method 200 is performed, the constituent currencies of the currency trend index 168 and the weight values assigned to each constituent have been determined.

At this point, an index value may be calculated using a method like the method 800 illustrated in FIG. 8 and discussed below) occasionally (e.g., periodically) for the currency trend index 168, and sent to the customer 180 (see FIG. 1). However, in block 810, the index value for the currency trend index 168 is calculated as follows. First, the computing device 110 calculates a contribution value for each constituent currency by multiplying the closing one-month future forward rate value for the currency determined on a selected trading day on the selected exchange by the weight value assigned to the constituent currency. Then, the computing device 110 totals the contribution values for the constituent currencies. Optionally, the computing device 100 multiplies this total by a number of units (e.g., 100) of the constituent currencies specified in future and/or short forward contracts. For example, in the table 400 illustrated in FIG. 4, on Jan. 24, 2013, the closing one-month future forward rate values of the candidate currencies NOK, NZD, SEK, CAD, USD, and JPY are 5.54519, 1.19402, 6.50089, 1.00391, 1.00000, and 89.98335, respectively. Further, in the table 1200 illustrated in FIG. 12, the weight values assigned to the candidate currencies NOK, NZD, SEK, CAD, USD, and JPY are 0.3333, 0.3333, 0.3333, −0.3333, −0.3333, and −0.3333 respectively. If the number of units is 100, the currency index value for Jan. 24, 2013 would be about −2,624.64 (−2,624.64=100*((5.54519*0.3333)+(1.19402*0.3333)+(6.50089*0.3333)+(1.00391*−0.3333)+(1.00000*−0.3333)+(89.98335*−0.3333))).

### Combined Currency Index

The combined currency index 162 may be constructed by combining the weight values assigned to the candidate currencies (see FIG. 3) in the currency carry index 164, the currency value index 166, and the currency trend index 168. For example, the weight values assigned to each of the candidate currencies by the indexes 164-168 may be averaged to obtain a weight value for the currency in the combined currency index 162.

FIG. 13 depicts a table 1300 with columns 1310, 1320, 1330, and 1340. The column 1310 lists the exemplary weight values assigned to each of the candidate currencies in the currency carry index 164. The column 1320 lists the exemplary weight values assigned to each of the candidate currencies in the currency value index 166. The column 1330 lists the exemplary weight values assigned to each of the candidate currencies in the currency trend index 168. The column 1340 lists the weight values assigned to each of the candidate currencies in the combined currency index 162. In this example, the weight value assigned to each currency in the combined currency index 162 is an average of the weight value assigned to the currency in the currency carry index 164, the weight value assigned to the currency in the currency value index 166, and the weight value assigned to the currency in the currency trend index 168.

The index value may be calculated occasionally (e.g., periodically, daily, monthly, etc.) as follows. First, the computing device 110 calculates a contribution value for each constituent currency by multiplying the closing one-month future forward rate value for the currency determined on a selected trading day on the selected exchange by the weight value assigned to the constituent currency. Then, the computing device 110 totals the contribution values for the constituent currencies. Optionally, the computing device 100 multiplies this total by a number of units (e.g., 100) of the constituent currencies specified in future and/or short forward contracts. For example, in the table 400 illustrated in FIG. 4, on Jan. 24, 2013, the closing one-month future forward rate values of the candidate currencies AUD, CAD, CHF, EUR, GBP, JPY, NOK, NZD, and SEK are 0.95694, 1.00391, 0.92993, 0.74756, 0.63369, 89.98335, 5.54519, 1.19402, and 6.50089, respectively. Further, the weight values assigned to the candidate currencies AUD, CAD, CHF, EUR, GBP, JPY, NOK, NZD, and SEK are 0.00, −0.11, −0.22, 0.00, 0.11, −0.22, 0.11, 0.22, and 0.11, respectively. If the number of units is 100, the currency index value for Jan. 24, 2013 would be about −1,864 (−1,864=100*((1.00391*−0.11)+(0.92993*−0.22)+(0.63369*0.11)+(89.98335*−0.22)+(5.54519*0.11)+(1.19402*0.22)+(6.50089*0.11))).

### Computing Device

FIG. 14 is a diagram of hardware and an operating environment in conjunction with which implementations of the one or more computing devices of the system 100 may be practiced. The description of FIG. 14 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 14 includes a general-purpose computing device in the form of the computing device 12. Each of the computing devices of FIG. 1 (including the computing devices 110, 120, 130, and 140) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 14 include a local-area network (LAN) 51 and a wide-area network (WAN) 52. Such networking environments are commonplace in offices, enterprise-wide computer networks, intranets and the Internet. The network 150 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200, 800, and 900 illustrated in FIGS. 2, 8, and 9, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method of constructing a currency carry index performed by one or more computing devices, the method comprising:
calculating a carry metric value for each of a plurality of currencies with respect to a base one of the plurality of currencies, for each of the plurality of currencies, the carry metric value being calculated based on a forward rate value associated with the currency, and a spot rate value associated with the currency;
ranking the plurality of currencies by their carry metric values;
selecting a portion of the plurality of currencies for inclusion in the currency carry index based at least in part on the ranking; and
assigning a weight value to each currency in the selected portion of the plurality of currencies, the currency carry index comprising the selected portion of the plurality of currencies weighted according to the weight value assigned to each currency in the selected portion.

2. The method of claim 1, wherein for each of the plurality of currencies, calculating the carry metric value comprises dividing the forward rate value associated with the currency by the spot rate value associated with the currency.

3. The method of claim 1, wherein for each of the plurality of currencies, the forward rate value associated with the currency is one of a plurality of forward rate values associated with the currency,
for each of the plurality of currencies, the spot rate value associated with the currency is one of a plurality of spot rate values associated with the currency, a different one of the plurality of spot rate values corresponding to each of the plurality of forward rate values and having been determined on the same trading day as the corresponding forward rate value, and
for each of the plurality of currencies, the carry metric value is calculated by (a) calculating a plurality of ratio values by dividing each of the plurality of forward rate values by the corresponding one of the plurality of spot rate values, and (b) calculating an average of the plurality of ratio values.

4. The method of claim 1, wherein the selected portion of the plurality of currencies comprises a first portion and a different second portion,
the first portion of the plurality of currencies comprises at least one currency selected for a long position in the currency carry index, and
the second portion of the plurality of currencies comprises at least one currency selected for a short position in the currency carry index.

5. The method of claim 4, wherein the weight value assigned to each currency in the first portion of the plurality of currencies is different from the weight values assigned to each currency in the second portion of the plurality of currencies.

6. The method of claim 5, wherein the weight value assigned to each currency in the first portion of the plurality of currencies is a positive value, and the weight value assigned to each currency in the second portion of the plurality of currencies is a negative value.

7. The method of claim 4, wherein the first portion of the plurality of currencies includes three highest ranking of the plurality of currencies;
the weight value assigned to each currency in the first portion of the plurality of currencies is positive one third,
the second portion of the plurality of currencies includes three lowest ranking of the plurality of currencies, and
the weight value assigned to each currency in the second portion of the plurality of currencies is negative one third.

8. The method of claim 4, wherein the first portion of the plurality of currencies comprises a predetermined number of the plurality of currencies having highest ranks, and the second portion of the plurality of currencies comprises a predetermined number of the plurality of currencies having lowest ranks.

9. The method of claim 4, wherein the first portion of the plurality of currencies includes a first number of the plurality of currencies;
the weight value assigned to each currency in the first portion of the plurality of currencies is equal to one divided by the first number,
the second portion of the plurality of currencies includes a second number of the plurality of currencies, and
the weight value assigned to each currency in the second portion of the plurality of currencies is equal to negative one divided by the second number.

10. The method of claim 1, further comprising:
calculating a plurality of contribution values by calculating a contribution value for each currency in the selected portion, each contribution value being calculated for a different currency in the selected portion by multiplying the forward rate value associated with the currency by the weight value assigned to the currency; and
calculating an index value by adding the plurality of contribution values together.

11. A computer-implemented method for use with a pool of candidate currencies, the method being performed by one or more computing devices, the method comprising:
identifying a first set of weight values assigned to the candidate currencies in a currency value index;
identifying a second set of weight values assigned to the candidate currencies in a currency trend index;
obtaining a plurality of forward rate values associated with each of the candidate currencies, each of the plurality of forward rate values having been determined at close of an exchange on a different trading day;
for each of the candidate currencies, obtaining a spot rate value corresponding to each of the plurality of forward rate values, each spot rate value having been determined on the same trading day as the forward rate value corresponding to the spot rate value;
calculating a carry metric value for each of the candidate currencies by (a) dividing each of the plurality of forward rate values associated with the candidate currency by the spot rate value corresponding to the forward rate to obtain a plurality of ratio values for the candidate currency, and (b) calculating an average of the plurality of ratio values for the candidate currency;
ranking the candidate currencies by their carry metric values;
selecting a portion of the candidate currencies for inclusion in a currency carry index based at least in part on the ranking;
identifying a third set of weight values by (a) assigning a weight value other than zero to each candidate currency in the selected portion of the candidate currencies, and (b) assigning a weight value equal to zero to any candidate currency not included in the selected portion of the candidate currencies; and
for each of the candidate currencies, calculating a combined weight value as a function of the weight value assigned to the candidate currency in the first set of weight values, the weight value assigned to the candidate currency in the second set of weight values, and the weight value assigned to the candidate currency in the third set of weight values, a combined currency index comprising as constituent currencies any of the candidate currencies having a combined weight value greater than zero, each constituent currency being weighted in the combined currency index according to the combined weight value calculated for the constituent currency.

12. The method of claim 11, wherein for each of the candidate currencies, the combined weight value is an average of the weight value assigned to the candidate currency in the first set of weight values, the weight value assigned to the candidate currency in the second set of weight values, and the weight value assigned to the candidate currency in the third set of weight values.

13. The method of claim 11, wherein the selected portion of the candidate currencies includes a first portion and a different second portion,
the first portion of the candidate currencies includes a first number of the candidate currencies each selected for a long position in the currency carry index,
the weight value assigned to each currency in the first portion of the candidate currencies is equal to one divided by the first number,
the second portion of the candidate currencies includes a second number of the candidate currencies each selected for a short position in the currency carry index, and
the weight value assigned to each currency in the second portion of the candidate currencies is equal to negative one divided by the second number.
